(19) United States
(12) Patent Application Publication
(10) Pub. No.: US 2007/0136355 A1
(43) Pub. Date: Jun. 14, 2007

(54) Method and system to detect and analyze clinical trends and associated business logic

(75) Inventor: Sultan Haider, Erlangen (DE)

Correspondence Address: SCHIFF HARDIN LLP;Patent Department, 6600 Sears Tower, 233 South Wacker Drive, Chicago, IL, 60606, US

(73) Assignee: Siemens Aktiengesellschaft

(21) Appl. No.: 11/300,574

(22) Filed: Dec. 14, 2005

(51) Int. Cl. G06F 7/00

(52) U.S. Cl. 707/102

(57) ABSTRACT

A method and system are provided for determining and analyzing clinical trend data. Unstructured data at a medical facility is classified utilizing a rule database into structured data, and associated with various parameter identifiers. The structure data is then statistically analyzed and graphical displays and/or reports are produced showing the relationships between data associated with the various parameters. The aggregation of large amounts of data from various sites permits trends to be recognized that would otherwise not be apparent.

### BACKGROUND

The present invention relates to a method and system to detect and analyze clinical trends and associated business logic for the medical community.

Medical facilities generate large amounts of data that is related to the medical procedures that are performed, research, and the business of running the facilities. A lot of information is generated at such facilities or clinics which could be used for improving the throughput and optimization processes both at the clinics as well as the product definition at the product manufacturers. Unfortunately, much of this data lacks organization and coherence, and therefore cannot be utilized effectively. Data that can be cross-correlated and analyzed in a consistent manner can produce substantially more useful information than that which is analyzed in isolation. This is particularly true when looking for trend data, and when examining data over long periods of time or across medical facilities, companies, countries, etc.

Presently, there is no reliable mechanism for obtaining disparate types of medicine-related information in a cohesive manner and using such data to detect clinical trends and the appertaining associated business logic. With respect to market trends and development, a reliable quantification of total technology related spending and processes has been impossible to obtain even with groups like marketing, development, workflow, etc. addressing the problem, given the inherent limitations of the organization of the data.

With respect to clinical trend detection, there has been no mechanism for determining trends such as whole body imaging, disease specific imaging, molecular imaging, etc., nor for assessing factors affecting clinical trends, e.g., economic growth in India and China resulting in rise in cardio vascular patients, natural calamities, political instabilities, etc. Customers with different focuses (e.g., research, clinical, academic, routine) and different assets (e.g., human resources, equipment, infrastructure), might need different functionalities and different ways to assess statistical information related to such data. What is needed is a method and system that has the ability to handle medical data in a consistent manner, detect and analyze clinical trends, and associate business logic for the medical community. While this could address very narrow factors such as the costs and timings of specific medical procedures using specific devices, this approach could also be used to address very broad factors such as competition, legislation and regulation, the cost of case studies and limitations, servicing, and consultancy for improving clinical, operational and financial performance.

### SUMMARY

The present invention achieves these goals by performing a structuring of unstructured data at a medical facility so that it is represented in a cohesive way, and then utilizing this structured and cohesive information to perform statistical and clinical trend detection which would not otherwise be possible without the use of the structured data. This approach permits, as possibilities, an analysis across various medical facilities, across procedures, across time, equipment, or countries, for example.

Advantageously, the system and method according to embodiments of the invention permit unparalleled insight into the real working environment and workflow with respect to diagnostic questions. For example, workflow sequences can be optimized and imaging routines standardized based on the information obtained, and markets for new software and hardware applications as well as new business models can be developed in response to the discerned clinical trends.

By way of a specific example, if it could be determined that a 5% better homogeneity in a magnet of a magnetic resonance imaging system results in a 15% better customer workflow, then a more knowledgeable business decision could be made that relates the cost of development to profit margin. At a higher level, the clinical trend information could be utilized to influence healthcare policies by providing consultancy and solutions to health care ministries of various countries and could play a significant role in global healthcare by, e.g., benchmarking with government organizations for planning costs and providing an insight about current and future diseases.

Knowledge of these trends permits software development protocol optimization, evaluation of work-in-progress (WIP), clinically acceptable image quality definition, HIS/RIS network planning, evaluation of diagnostic procedures, development of new sequences, applications, etc. If one can foresee defects in appertaining hardware and software, then one could advise the customer about patient scheduling. In this environment, information related to best practices can be shared which benefits everyone involved.

As far as the customer is concerned, clinical trend knowledge can permit a higher throughput, reduced workforce, cost reductions, better and faster servicing, and higher up time for appertaining systems. This information can benefit the patient by indicating the shortest time for particular diagnostics.

It is important, however, to identify general parameters that describe certain states and/or workflow steps along with other crucial information required in order to draw the correct conclusions out of the collected data.

Specific details with respect to the method and system are provided by way of example.

### DESCRIPTION OF THE DRAWINGS

The invention is best understood with reference to the various embodiments illustrated in the figures and appertaining description below.

FIG. 1 is a block diagram illustrating the various system components according to a preferred embodiment of the invention.

FIG. 2 is a pictorial illustrating indicating the interdependent nature of the primary data types;

FIGS. 3A-E are graphs illustrating various analysis parameters based on the structured data received by the clinical trend detection system;

FIGS. 4A, B are additional graphs illustrating various analysis parameters based on the structured data received by the clinical trend detection system; and

FIGS. 5A-G are tables providing exemplary performance indicators for a variety of environments.

### DETAILED DESCRIPTION OF THE PREFERRED EMBODIMENTS

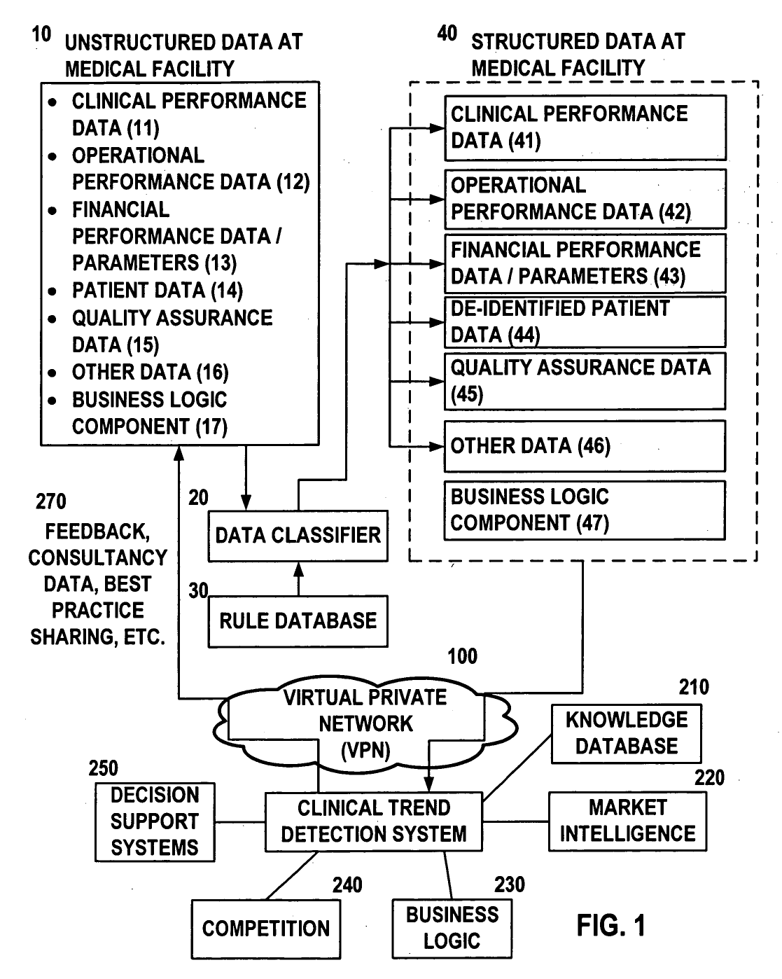

FIG. 1 is a block diagram illustrating the context in which an embodiment of a clinical trend detection system 200 operates in.

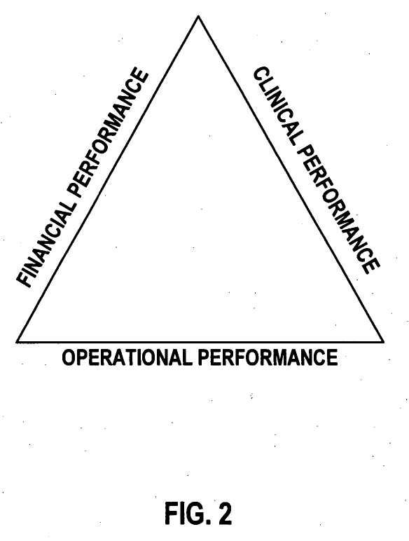

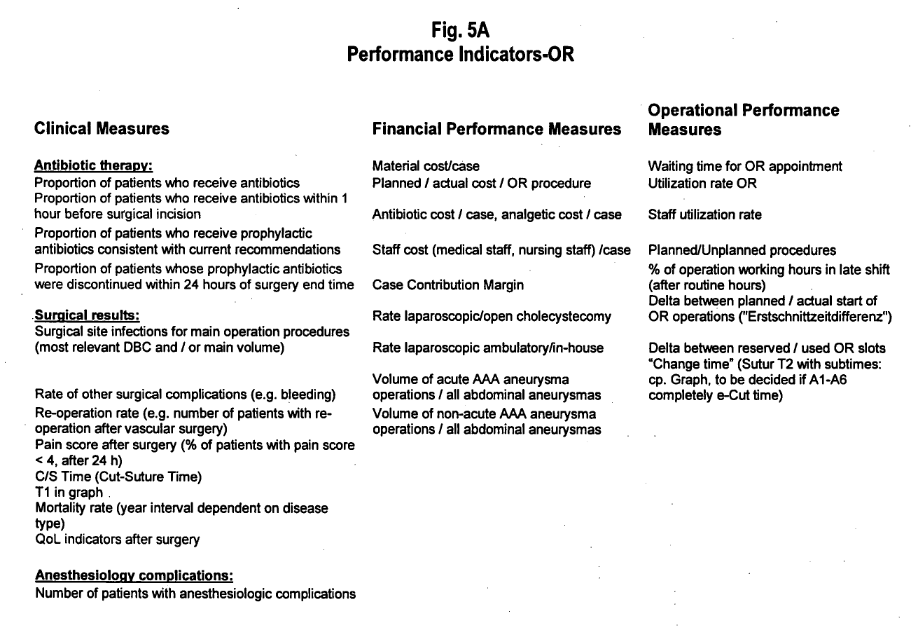

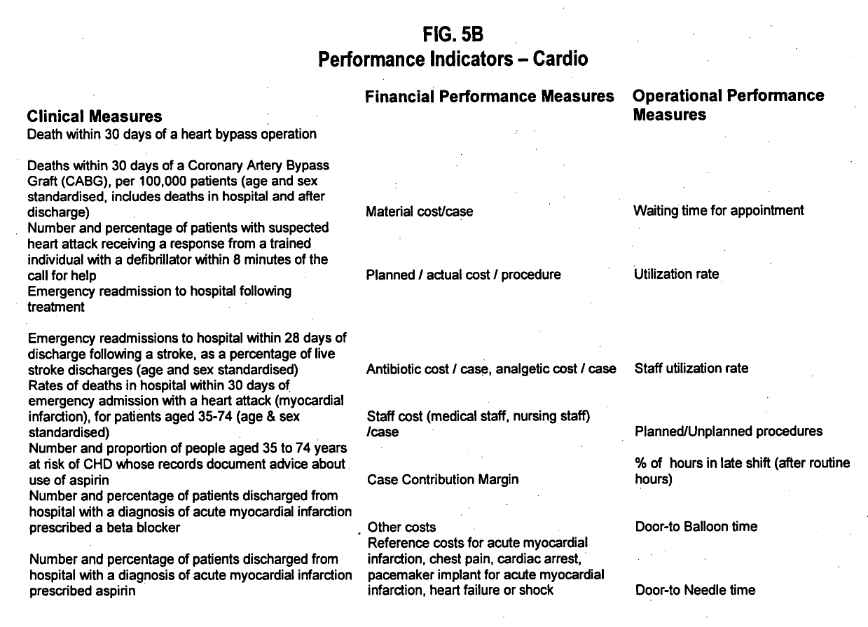

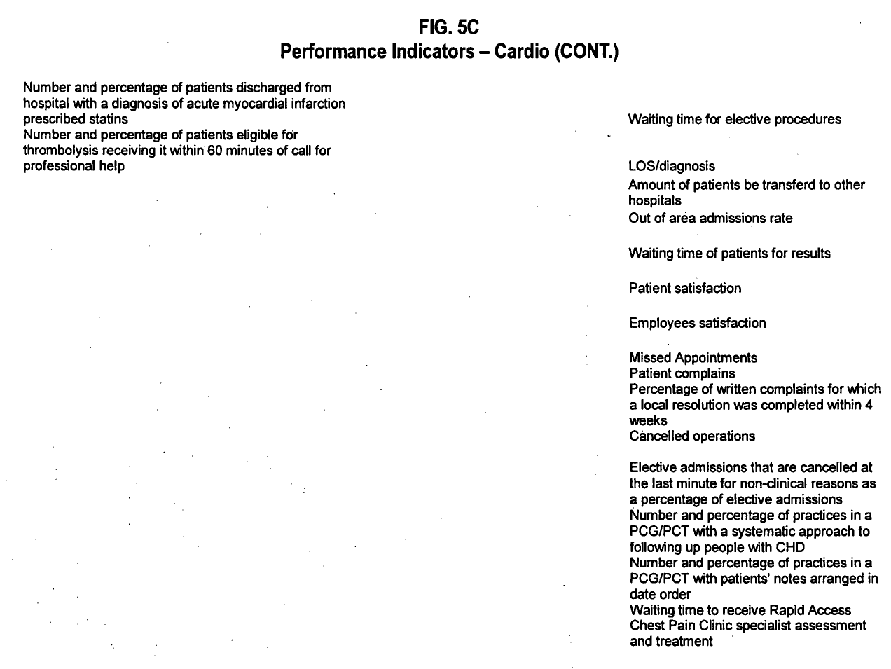

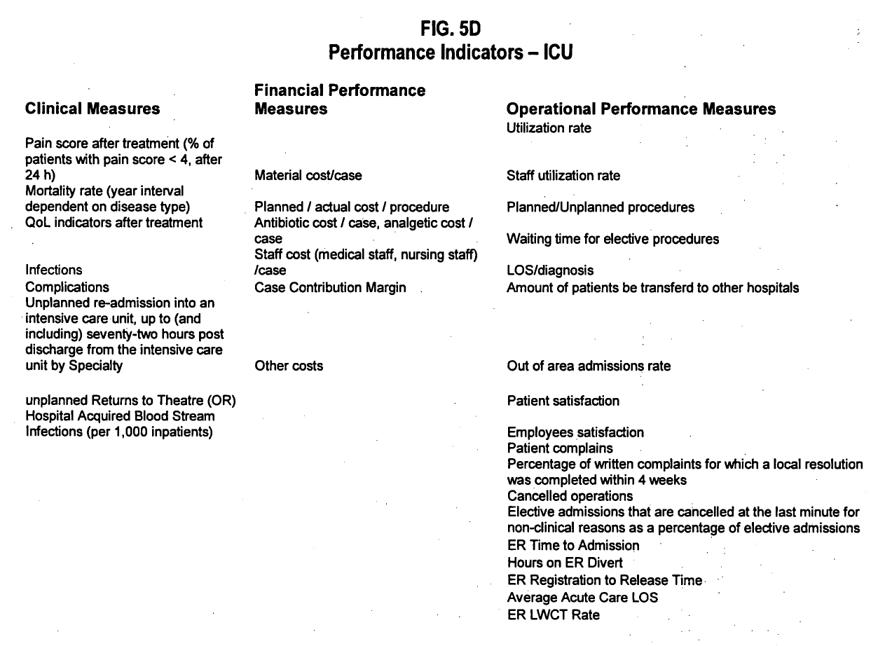

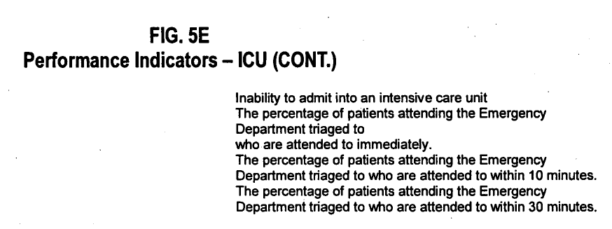

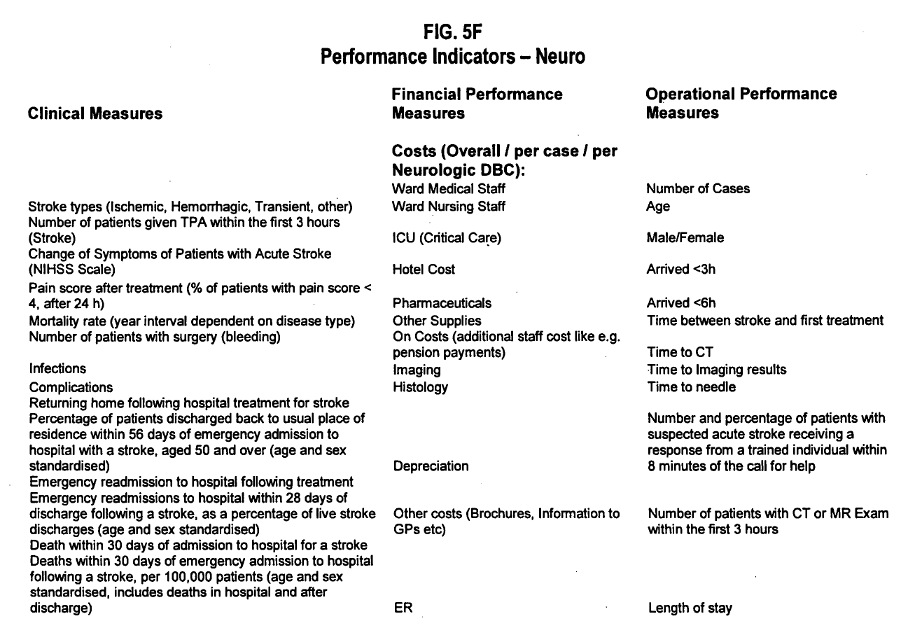

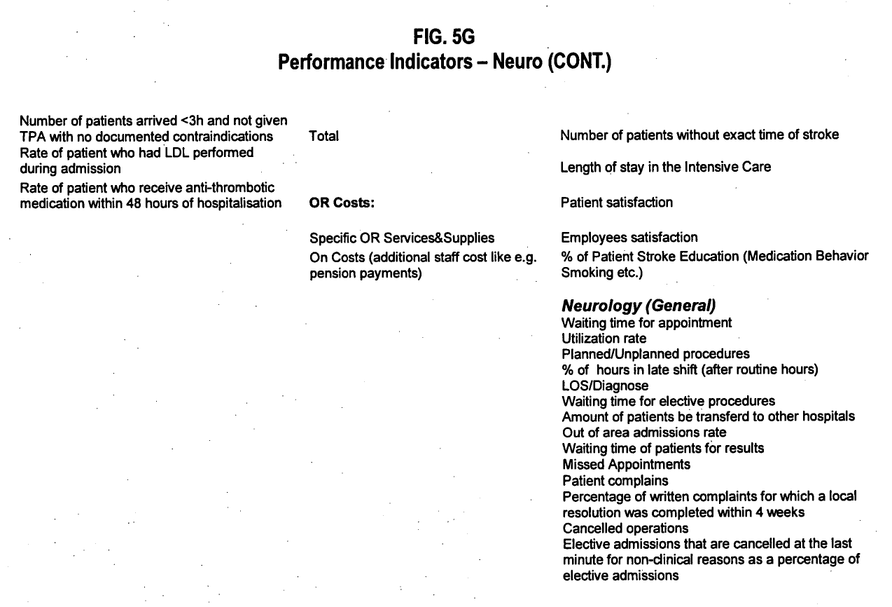

A particular medical facility has unstructured data 10 stored at or associated with the facility. This data may be spread across different computer systems, stored in different formats and in different databases, have different mechanisms for access, etc. However, this data can include three primary types of data that can be interrelated: clinical performance data 11, operational performance data 12 (including data for equipment and for IT component usage), and financial performance parameters and data 13 (see FIG. 2, showing the triangle of interrelated performance data). FIGS. 5A-G provide examples of various performance indicators associated with the clinical measures, financial performance, and operational performance in the context of the operating room OR (FIG. 5A), Cardio (FIGS. 5B, C), intensive care unit ICU (FIGS. 5D, E), and Neuro (FIGS. 5F, G). It should be noted that these are provided only by way of example.

In addition to these primary types of data, other data will likely be present, such as patient data 14 that relates to specific patients, quality assurance data 14 that may be required by governmental agencies, such as the FDA or OSHA or that may be useful for certification, such as ISO-9000.

Various other data 16 may be present, as well as data related to business logic 17. The business logic component 17 is explained in more detail further below, but basically comprises factors that are related to a care center and indicate why certain medical facilities may be better in some areas that others (e.g., education of the staff, or the ability of staff members to speak a certain languages). All of this information is generated during the operation of a medical facility and can include data such as text, database, image, video, or any other form of data.

In order to provide structured data 40 at a medical facility, which permits consistency and cohesiveness to the disparate data of the unstructured data 10, a data classifier 20, utilizing a rule database 30, is used. Since the form, location, and access methods of the unstructured data 10 will vary from facility to facility (by its very nature and definition as “unstructured”), a representative of the facility will participate in the creation of the rule database 30 that can be used by the data classifier 20. This helps the healthcare providers (equipment manufacturers and IT solutions provider) to organize their R & D and services.

Once fully developed, the data classifier 20 and the rule database 30 should be able to run in a completely or primarily automated manner. It may operate in a periodically polled manner or may be interrupt driven based on various events.

The classifier 20 utilizes known data mining tools for statistical analysis which could make use of artificial neural network classifiers, Bayesian methods, genetic algorithms, estimation methods, etc.

The data classifier 20 provides structure to the unstructured data 40 and processes the primary data components into, respectively, the clinical performance data 41, the operational performance data 42, and the financial performance data 43. The additional data may also be structured. De-identified or anonymized patent data 44 may be collected. The information is de-identified in order to prevent violation of various privacy laws and to otherwise help keep information confidential as it relates to an identifiable patient. The anonymization can take place on an individual patient record simply by substituting a unique identifier in place of the patient's name, or could aggregate multiple patent records into a summary record of some sort.

The other data 46 is structured, as is the data associated with the business logic component 47. A business logic component 47 is a component that helps assess the rationale behind various processes that may be present. The business logic of an organization is a function of its operational, financial and clinical performance, and relates to the various factors that explain a particular business rationale for operating in a particular way.

If represented mathematically, the business logic 45 could be represented by the following equation:
business logic[b1,b2 . . . bn]=F[
financial performance(w1*f1+w2*f2+ . . . +wn*fn),
operational performance(w1*o1+w2*o2+ . . . +wn*on),
clinical performance(w1*c1+w2*c2+ . . . +wn*cn)] (1);
where
f1, f2 . . . fn are financial performance parameters,
o1, o2 . . . on are the operational performance parameters,
c1, c2 . . . cn are the clinical performance parameters,
FB can be a non-linear or linear function,
w1, w2, . . . wn are weighing parameters, and
b1, b2 . . . . bn are the various factors explaining the business logic of an organization

The various factors b1-bn for the business logic 45 can related to the type of institution (e.g., a cardiology hospital, neurology hospital, research site, care center, private hospital, government hospital, educational institution), as well as various success criteria such as why certain clinical facilities are rated better then others, such as the education of the staff, and other relevant business related data, such as whether a site is suitable for clinical trails and potentials for improvement in business.

By way of a specific example, the business logic component 45 may contain information as to why certain examination procedures or processes are followed in a particular geographical region. This is illustrated by the fact that due to the large presence of rectal cancers in Japan, whole body diffusion imaging is popular in Japan. It can be shown that chemical shift selective-diffusion weighted imaging (CHESS-DWI) is better in detecting lesions in a number of anatomical regions compared to short tau inversion recovery-diffusion weighted imaging (STIR-DWI). MR/CT/US/MI applications to be used in a region depend upon the presence of certain diseases, the monitoring of which needs special attention for product development.

The following example illustrates what kind of protocols or workflows may be followed for patients in a specific age group with, e.g., acute chest pain in a certain geographical region.

Example workflow:
Emergency intake→anamneses→ecg, lab tests→catheter laboratory→CT/MR follow-up scan

The health care provider could create benchmarking and provide consultancy to the customer by identifying the interdependence of the operational, financial and clinical performance parameters. The financial performance 43 can be defined by the following equation:
financial performance (w1*f1+w2*f2+ . . . +wn*fn)=F[
operational performance(w1*o1+w2*o2+ . . . +wn* on),
clinical performance(w1*c1+w2*c2+ . . . +wn*cn)] (2)

An example of the user of financial performance, in a case of cardiac MR imaging, in a situation where a change of breathing pattern results due to patient movement, complete data gets lost (since the patient must generally not move); however, the acquired data might be of clinically acceptable image quality. Considering 1 min. at an MR scanner costs [symbol] 30, a patient movement after 8 mins. of examination costs [symbol] 240. The MR manufacturer provides consultancy for buying special navigator sequences robust to patient movement or provides viewing options for looking at the acquired data, thereby, improving the financial, clinical and financial performance of the clinical facility.

The rule database 30 reflects a-priori knowledge acquired from the clinicians, e.g., whether it makes sense to have a high financial performance with low clinical performance (e.g., a high mortality rate or other designation of low performances). This could be based on clinical guidelines.

The structuring and analysis of the data can make use of a large number of parameters. The following list, while extensive, is by no means a limiting list of the various parameters associated with the structured data. It is broken out into the following broad groupings: post processing, equipment, patient, study, series and image. This approach permits a universal language by which the facilities can share their data for trend detection and analysis.

PostProcessing

| | |
|---|---|
| PP1 | Advanced3D |
| PP2 | InteractiveRealtimeImaging |
| PP3 | AdvancedCardiacPackage |
| PP4 | FlowQuantification |
| PP5 | AdvancedAngioPackage |
| PP6 | CAREBolus |
| PP7 | PanoramicTable |
| PP8 | EchoPlanarImaging |
| PP9 | BoldImaging |
| PP10 | BoldEvaluation |
| PP11 | AdvancedTurboPackage |
| PP12 | Spectroscopy:SVS |
| PP13 | Spectroscopy:CSI |
| PP14 | TGSE |
| PP15 | ImageFilterSoftware |
| PP16 | MeanCurve |

Equipment

| | |
|---|---|
| EQ1 | DeviceSerialNumber |
| EQ2 | InstitutionName |

Patient

| | |
|---|---|
| PA1 | PatientsSex |
| PA3 | Uid |
| PA4 | InstanceCreationDate |
| PA5 | InstanceCreationTime |

Study

| | |
|---|---|
| ST1 | StudyInstanceUID |
| ST2 | StudyDate |
| ST3 | StudyTime |
| ST4 | NumberOfSeries |
| ST5 | NumberOfImages |
| ST6 | PhysiciansOfRecord |
| ST7 | ReferringPhysiciansName |
| ST8 | StudyDescription |

Series

| | |
|---|---|
| SE1 | SeriesInstanceUID |
| SE2 | SeriesDate |
| SE3 | SeriesTime |
| SE4 | BodyPartExamined |
| SE5 | sCOIL_SELECT_MEAS.asList[ ].sCoilElementID.tCoilID |
| SE6 | sCOIL_SELECT_MEAS.asList[ ].sCoilElementID.tElement |
| SE7 | SeriesDescription |
| SE8 | PerformingPhysiciansName |
| SE9 | OperatorsName |
| SE10 | SarWholeBody |
| SE11 | tSequenceFileName |
| SE12 | dBdt_thresh |
| SE13 | PatientPosition |
| SE14 | sGroupArray.sPSat.nCount |
| SE15 | sSliceArray.sTSat.ucOn |
| SE16 | sSliceArray.ISize |
| 4SE17 | sSliceArray.asSlice[ ].sNormal.dSag |
| SE18 | sSliceArray.asSlice[ ].sNormal.dCor |
| SE19 | sSliceArray.asSlice[ ].sNormal.dTra |
| SE20 | sRSatArray.ISize |
| SE21 | sRSatArray.asEIm[ ].sNormal.dSag |
| SE22 | sRSatArray.asEIm[ ].sNormal.dCor |
| SE23 | sRSatArray.asEIm[ ].sNormal.dTra |
| SE24 | sPrepPulses.ucFatSat |
| SE25 | sPrepPulses.ucMTC |
| SE26 | sPrepPulses.ucWaterSat |
| SE27 | ucOneSeriesForAllMeas |
| SE28 | IScanTimeSec |
| SE29 | ITotalScanTimeSec |
| SE30 | tProtocolName |

Image

| | |
|---|---|
| IM1 | AcquisitionNumber |
| IM2 | ImagesInAcquisition |
| IM3 | RepetitionTime |
| IM4 | InversionTime |
| IM5 | EchoTime |
| IM6 | FlipAngle |
| IM7 | NumberOfAverages |
| IM8 | ContrastBolus IsSet=yes |
| IM9 | SliceThickness |
| IM10 | NumberOfFrames |
| IM11 | FOV |
| IM12 | AcquisitionMatrixText |
| IM13 | SliceMeasurementDuration |

The clinical trend detection system 200 utilizes the structured data 40 of the medical facility to provide analysis and trend information that relates to this structured data 40 as well as any other data from other facilities that has been collected. The system 200 is configured to run on any type of computer comprising a CPU, storage, user interface, and input/output that is well known in the art.

In a general sense, clinical trends in organizations are functions of operational and clinical performance. The following equation describes this relationship:
clinical trends[CT1,CT2. . . . CTn]=F[
clinical performance(w1*c1+w2*c2+ . . . +wn*cn),
operational performance(w1*o1+w2*o2+ . . . +wn* on)] (3);
where
CT1, CT2. . . . CTn are the criterion, such as whole body imaging, making use of whole body MRI and CT scanners, disease specific imaging, certain imaging techniques used for patients with certain symptoms.

In one configuration, the system 200 is installed locally at the customer site for the internal evaluation of the structured data 40 and its appertaining performance parameters. However, the system 200 can also be installed remotely and globally accessible by other medical facilities as well. In such a configuration, adequate data protection mechanisms should be employed, such as the use of a secure communication link via, e.g., a virtual private network (VPN). Additionally, the system 200 also may implement known authentication and authorization mechanism to ensure proper access to the information, such as username/password combinations and biometric identification techniques, such as smart cards. The system 200 may also make use of encryption for secure data transfer between the clinical trend system 200 and various medical facilities. However, the system 200 may also implement a call center via which it could be accessed.

The data sent to a remotely located system 200 can implement any number of known business models for processing the structured data 40 for a particular facility, e.g., on a pay per use bases.

The structured data 40 may be stored and communicated in any number of formats, e.g., using known database structures such as Oracle, Microsoft Access, and using known query techniques such as SQL. The data may also be stored and communicated in a more web-centric manner, such as by using XML files.

By way of example, at a magnetic resonance (MR) imaging site, three files are generated:

Patient_{—}1

Series_{—}1

Config_Statistics

These files contain information about how many patients were examined that day, when and how long each patient was in the scanner, how many studies and images were performed for each patient, etc. Furthermore, each study is described and provides insight in Study- Series- and Image-Objects acquired. These files may actually be transmitted separately, or may be compressed and combined, for example, in a zip file. Such a zip file could utilize a date and time stamp in the file name itself. The file(s) could be pushed to a server when an examination is complete, or could be polled and pulled by the server on a periodic basis or according to any know transmission and synchronization scheme.

In the XML implementation, a rough overview of the data content of the three files described above may be described as follows:

PATIENT_1

<?xml version=“1.0” encoding=“UTF-8”?>
<AllPatients>
<Patient ID=“1” Date=“ ” Time=“ ” SerialNumber=“ ”
StartDate=“ ”
StartTime=“ ” StopDate=“ ” StopTime=“ ” SeriesCount=“ ”
ImageCount=“ ”
PatLoid=“ ” />
</AllPatients>

SERIES_1

<?xml version=“1.0” encoding=“UTF-8”?>
<AllSeries>
<Series>
<General ID=“1” Date=“ ” Time=“ ” PatID=“1”
StartDate=“ ”
StartTime=“ ” StopDate=“ ” StopTime=“ ” ImageCount=“1”/>
<Attribute ID=“EQ1” Value=“22188” />
</Series>
</AllSeries>

CONFIG_STATISTICS

<?xml version=“1.0” encoding=“ISO-8859-2”?>
<?xml-stylesheet type=“text/xsl” href=“Statistics.xsl”?>
<Config_Statistics>
<General>

<AttributeWithText ID=“Status” Name=“ ” Text=“ ”/>
<AttributeSelection ID=“GE1_” Name=“Region”>

<Option Selected=“yes”>Portugal</Option>

</AttributeSelection>

</General>
<Global>

<Activation ID=“GlobalSwitch” Name=“SUA ”
Statistic_on=“yes”/>
<Version ID=“Configuration” Text=“1.0”/>

</Global>
<PostProcessing>

<Attribute ID=“PP1” Name=“Advanced3D”
Statistic_on=“no”/>

</PostProcessing>
<Equipment>

<AttributeDisabled ID=“EQ1” Name=“DSN”
Statistic_on=“yes”

Required=“yes”/>
</Equipment>
<Patient>

<Attribute ID=“PA1” Name=“PatientsSex”
Statistic_on=“yes”/>

</Patient>
<Study>

<Attribute ID=“ST1” Name=“StudyInstanceUID”

Statistic_on=“yes”/>
</Study>
<Series>

<Attribute ID=“SE1” Name=“SeriesInstanceUID”

Statistic_on=“yes”/>
</Series>
<Image>

<Attribute ID=“IM1” Name=“AcquisitionNumber”

Statistic_on=“yes”/>
</Image>
</Config_Statistics>

A more thorough example of the Config_Statistics file utilizing numerous of the previously presented parameters is provided by way of example below.

<?xml version=“1.0”?>
<!DOCTYPE Config_Statistics SYSTEM
“http://localhost/SysUtilXML/Config_Statistics.dtd”>
<?xml-stylesheet type=“text/xsl”
href=“http://localhost/SysUtilXML/Config_Statistics.xsl”?>
<Config_Statistics>

<General>

<AttributeWithText ID=“Status” Name=“ ” Text=“ ”/>
<AttributeSelection ID=“GE1_” Name=“Region”>

<Option Selected=“no”>Australia</Option>
<Option Selected=“no”>Austria</Option>
<Option Selected=“no”>Belgium</Option>
<Option Selected=“no”>Brasil</Option>
<Option Selected=“no”>Canada</Option>
<Option Selected=“no”>China</Option>
<Option Selected=“no”>Czech Republic</Option>
<Option Selected=“no”>Denmark</Option>
<Option Selected=“no”>Egypt</Option>
<Option Selected=“no”>Finland</Option>
<Option Selected=“no”>France</Option>
<Option Selected=“no”>Germany</Option>
<Option Selected=“no”>Greece</Option>
<Option Selected=“no”>Hong Kong</Option>
<Option Selected=“no”>Hungary</Option>
<Option Selected=“no”>India</Option>
<Option Selected=“no”>Ireland</Option>
<Option Selected=“no”>Italy</Option>
<Option Selected=“no”>Japan</Option>
<Option Selected=“no”>Jordan</Option>
<Option Selected=“no”>Netherlands</Option>
<Option Selected=“no”>New Zealand</Option>
<Option Selected=“no”>North Korea</Option>
<Option Selected=“no”>Norway</Option>
<Option Selected=“no”>Portugal</Option>
<Option Selected=“no”>Saudi Arabia</Option>
<Option Selected=“no”>Singapore</Option>
<Option Selected=“no”>South Africa</Option>
<Option Selected=“no”>South Korea</Option>
<Option Selected=“no”>Spain</Option>
<Option Selected=“no”>Sweden</Option>
<Option Selected=“no”>Switzerland</Option>
<Option Selected=“no”>Taiwan</Option>
<Option Selected=“no”>Thailand</Option>
<Option Selected=“no”>Turkey</Option>
<Option Selected=“no”>United Arabien

Emirats</Option>

<Option Selected=“no”>United Kingdom</Option>
<Option Selected=“no”>United States

[NorthEast] </Option>

<Option Selected=“no”>United States

[NorthMiddle] </Option>

<Option Selected=“no”>United States

[NorthWest] </Option>

<Option Selected=“no”>United States

[SouthEast] </Option>

<Option Selected=“no”>United States

[SouthMiddle] </Option>

<Option Selected=“no”>United States

[SouthWest] </Option>

<Option Selected=“no”>Venezuela</Option>
<Option Selected=“no”>others</Option>

</AttributeSelection>
<AttributeSelection ID=“GE2_” Name=“Type of Institution”>

<Option Selected=“no”>University</Option>
<Option Selected=“no”>Hospital</Option>
<Option Selected=“no”>Imaging Center</Option>

</AttributeSelection>
<AttributeSelection ID=“GE3_” Name=“Speciality”>

<Option Selected=“no”>Research</Option>
<Option Selected=“no”>Routine</Option>
<Option Selected=“no”>Teaching</Option>

</AttributeSelection>
<AttributeSelection ID=“GE4_” Name=“Patient mix (In-

Patients vs. Out-Patients)”>

<Option Selected=“no”>less In-Patients than Out-

Patients</Option>

<Option Selected=“no”>same In-Patients as Out-

Patients</Option>

<Option Selected=“no”>more In-Patients than Out-

Patients</Option>

</AttributeSelection>
<AttributeSelection ID=“GE5_” Name=“SystemType”>

<Option Selected=“no”>LowField (smaller 1T)</Option>
<Option Selected=“no”>High Field (1T and

more)</Option>

</AttributeSelection>
<AttributeWithText ID=“GE1” Name=“Region” Text=“select”/>
<AttributeWithText ID=“GE2” Name=“Type of Institution”

Text=“select”/>

<AttributeWithText ID=“GE3” Name=“Speciality”

Text=“select”/>

<AttributeWithText ID=“GE4” Name=“Patient mix”

Text=“select”/>

<AttributeWithText ID=“GE5” Name=“SystemType”

Text=“select”/>

</General>
<Global>

<Activation ID=“GlobalSwitch” Name=“System Utilization

Activated” Statistic_on=“no”/>

<Version ID=“Configuration” Text=“1.0”/>
<Version ID=“Syngo” Text=“ ”/>
<Version ID=“Numaris4” Text=“ ”/>
<Version ID=“Labels” Text=“ ”/>

</Global>
<PostProcessing>

<Attribute ID=“PP1” Name=“Advanced3D”
Statistic_on=“no”/>
<Attribute ID=“PP2” Name=“InteractiveRealtimeImaging”

Statistic_on=“no”/>

<Attribute ID=“PP3” Name=“AdvancedCardiacPackage”

Statistic_on=“no”/>

<Attribute ID=“PP4” Name=“FlowQuantification”

Statistic_on=“no”/>

<Attribute ID=“PP5” Name=“AdvancedAngioPackage”

Statistic_on=“no”/>

<Attribute ID=“PP6” Name=“CAREBolus” Statistic_on=“no”/>
<Attribute ID=“PP7” Name=“PanoramicTable”

Statistic_on=“no”/>

<Attribute ID=“PP8” Name=“EchoPlanarImaging”

Statistic_on=“no”/>

<Attribute ID=“PP9” Name=“BoldImaging”

Statistic_on=“no”/>

<Attribute ID=“PP10” Name=“BoldEvaluation”

Statistic_on=“no”/>

<Attribute ID=“PP11” Name=“AdvancedTurboPackage”

Statistic_on=“no”/>

<Attribute ID=“PP12” Name=“Spectroscopy:SVS”

Statistic_on=“no”/>

<Attribute ID=“PP13” Name=“Spectroscopy:CSI”

Statistic_on=“no”/>

<Attribute ID=“PP14” Name=“TGSE” Statistic_on=“no”/>
<Attribute ID=“PP15” Name=“ImageFilterSoftware”

Statistic_on=“no”/>

<Attribute ID=“PP16” Name=“MeanCurve”

Statistic_on=“yes”/>

</PostProcessing>
<Equipment>

<AttributeDisabled ID=“EQ1” Name=“DeviceSerialNumber”

Statistic_on=“yes” Required=“yes”/>

<AttributeDisabled ID=“EQ2” Name=“InstitutionName”

Statistic_on=“yes” Required=“yes” ParseIt=“yes”/>

</Equipment>
<Patient>

<Attribute ID=“PA1” Name=“PatientsSex”

Statistic_on=“yes”/>

<Attribute ID=“PA3” Name=“Uid” Statistic_on=“yes”/>
<Attribute ID=“PA4” Name=“InstanceCreationDate”

Statistic_on=“yes”/>

<Attribute ID=“PA5” Name=“InstanceCreationTime”

Statistic_on=“yes”/>

</Patient>
<Study>

<Attribute ID=“ST1” Name=“StudyInstanceUID”

Statistic_on=“yes”/>

<Attribute ID=“ST2” Name=“StudyDate” Statistic_on=“yes”/>
<Attribute ID=“ST3” Name=“StudyTime” Statistic_on=“yes”/>
<Attribute ID=“ST4” Name=“NumberOfSeries”

Statistic_on=“yes”/>

<Attribute ID=“ST5” Name=“NumberOfImages”

Statistic_on=“yes”/>

<Attribute ID=“ST6” Name=“PhysiciansOfRecord”

Statistic_on=“yes”/>

<Attribute ID=“ST7” Name=“ReferringPhysiciansName”

Statistic_on=“yes” ParseIt=“yes”/>

<Attribute ID=“ST8” Name=“StudyDescription”

Statistic_on=“yes” ParseIt=“yes”/>

</Study>
<Series>

<Attribute ID=“SE1” Name=“SeriesInstanceUID”

Statistic_on=“yes”/>

<Attribute ID=“SE2” Name=“SeriesDate”

Statistic_on=“yes”/>

<Attribute ID=“SE3” Name=“SeriesTime”

Statistic_on=“yes”/>

<Attribute ID=“SE4” Name=“BodyPartExamined”

Statistic_on=“yes”/>

<Attribute ID=“SE5”

Name=“sCOIL_SELECT_MEAS.asList [ ] .sCoilElementID.tCoilID”
Statistic_on=“yes”/>

<Attribute ID=“SE6”

Name=“sCOIL_SELECT_MEAS.asList [ ] .sCoilElementID.tElement”
Statistic_on=“yes”/>

<Attribute ID=“SE7” Name=“SeriesDescription”

Statistic_on=“yes” ParseIt=“yes”/>

<Attribute ID=“SE8” Name=“PerformingPhysiciansName”

Statistic_on=“yes”/>

<Attribute ID=“SE9” Name=“OperatorsName”

Statistic_on=“yes”/>

<Attribute ID=“SE10” Name=“SarWholeBody”

Statistic_on=“yes”/>

<Attribute ID=“SE11” Name=“tSequenceFileName”

Statistic_on=“yes” ExpandIt=“yes”/>

<Attribute ID=“SE12” Name=“dBdt_thresh”

Statistic_on=“yes”/>

<Attribute ID=“SE13” Name=“PatientPosition”

Statistic_on=“yes”/>

<Attribute ID=“SE14” Name=“sGroupArray.sPSat.nCount”

Statistic_on=“yes”/>

<Attribute ID=“SE15” Name=“sSliceArray.sTSat.ucOn”

Statistic_on=“yes”/>

<Attribute ID=“SE16” Name=“sSliceArray.1Size”

Statistic_on=“yes”/>

<Attribute ID=“SE17”

Name=“sSliceArray.asSlice [ ] .sNormal.dSag” Statistic_on=“yes”/>

<Attribute ID=“SE18”

Name=“sSliceArray.asSlice [ ] .sNormal.dCor” Statistic_on=“yes”/>

<Attribute ID=“SE19”

Name=“sSliceArray.asSlice [ ] .sNormal.dTra” Statistic_on=“yes”/>

<Attribute ID=“SE20” Name=“sRSatArray.1Size”

Statistic_on=“yes”/>

<Attribute ID=“SE21”

Name=“sRSatArray.asElm [ ] .sNormal.dSag” Statistic_on=“yes”/>

<Attribute ID=“SE22”

Name=“sRSatArray.asElm [ ] .sNormal.dCor” Statistic_on=“yes”/>

<Attribute ID=“SE23”

Name=“sRSatArray.asElm [ ] .sNormal.dTra” Statistic_on=“yes”/>

<Attribute ID=“SE24” Name=“sPrepPulses.ucFatSat”

Statistic_on=“yes”/>

<Attribute ID=“SE25” Name=“sPrepPulses.ucMTC”

Statistic_on=“yes”/>

<Attribute ID=“SE26” Name=“sPrepPulses.ucWaterSat”

Statistic_on=“yes”/>

<Attribute ID=“SE27” Name=“ucOneSeriesForAllMeas”

Statistic_on=“yes”/>

<Attribute ID=“SE28” Name=“1ScanTimeSec”

Statistic_on=“yes”/>

<Attribute ID=“SE29” Name=“1TotalScanTimeSec”

Statistic_on=“yes”/>

<Attribute ID=“SE30” Name=“tProtocolName”

Statistic_on=“yes”/>

</Series>
<Image>

<Attribute ID=“IM1” Name=“AcquisitionNumber”

Statistic_on=“yes”/>

<Attribute ID=“IM2” Name=“ImagesInAcquisition”

Statistic_on=“yes”/>

<Attribute ID=“IM3” Name=“RepetitionTime”

Statistic_on=“yes”/>

<Attribute ID=“IM4” Name=“InversionTime”

Statistic_on=“yes”/>

<Attribute ID=“IM5” Name=“EchoTime” Statistic_on=“yes”/>
<Attribute ID=“IM6” Name=“FlipAngle” Statistic_on=“yes”/>
<Attribute ID=“IM7” Name=“NumberOfAverages”

Statistic_on=“yes”/>

<Attribute ID=“IM8” Name=“ContrastBolus”

Statistic_on=“yes” IsSet=“yes”/>

<Attribute ID=“IM9” Name=“SliceThickness”

Statistic_on=“yes”/>

<Attribute ID=“IM10” Name=“NumberOfFrames”

Statistic_on=“yes”/>

<Attribute ID=“IM11” Name=“FOV” Statistic_on=“yes”/>
<Attribute ID=“IM12” Name=“AcquisitionMatrixText”

Statistic_on=“yes”/>

<Attribute ID=“IM13” Name=“SliceMeasurementDuration”

Statistic_on=“yes”/>

</Image>

</Config_Statistics>

The clinical trend detection system 200 builds a decision and business logic 230 allowing the user to add or remove various clinical, operational and financial performance parameters.

FIG. 1 illustrates additional sources of information that may be utilized by the clinical trend detection system 200, including a knowledge database 210 encompassing acquired knowledge from both sides (user, supplier), market intelligence 220 (e.g., information pertaining to supply and demand of products, services, etc.), external business logic 230, information related to competitors and competitive issues 240, as well as a decision support system 250.

The system may utilize artificial neural networks, Bayesian methods, genetic algorithms, etc., for a self learning mechanism for processing the various performance parameters. The system could also provide feedback and consultancy 270 on various levels (such as standard information about one clinical facility, advanced information about the analysis/comparative information with other clinical facilities, best practice sharing, etc.) Access to the feedback information 270 can be in the form of reports, which may be purchased and can be used, in part, as an incentive to encourage organizations to share their data with others.

Reports and/or displays on user interface devices can be accessed by a customer either electronically, or in paper form, and can ultimately be saved as, e.g., PDF documents or other universally known data formats. The customer could generate reports based on his business logic or any other criteria of interest. The problem is not about the amount of data available in a clinical facility, the real problem lies in the selection of right amount of data, e.g., what kind of data should be used to see the financial performance on a daily bases for a CEO, CFO and CIO. The content would likely be different as would be the presentation state. The health care provider could provide reports on a pay per use models with certain contracts such as Yearly contracts for reports (to be provided on a daily basis) costs: CIO costs [symbol] 30K, CEO [symbol] 30K, CFO [symbol] 30K, Head Cardiology [symbol] 15k, Head Neuro [symbol] 15k, Ambulatory Care [symbol] 5k etc] Physician [symbol] 2k, Workflow Automation 250K, etc.)

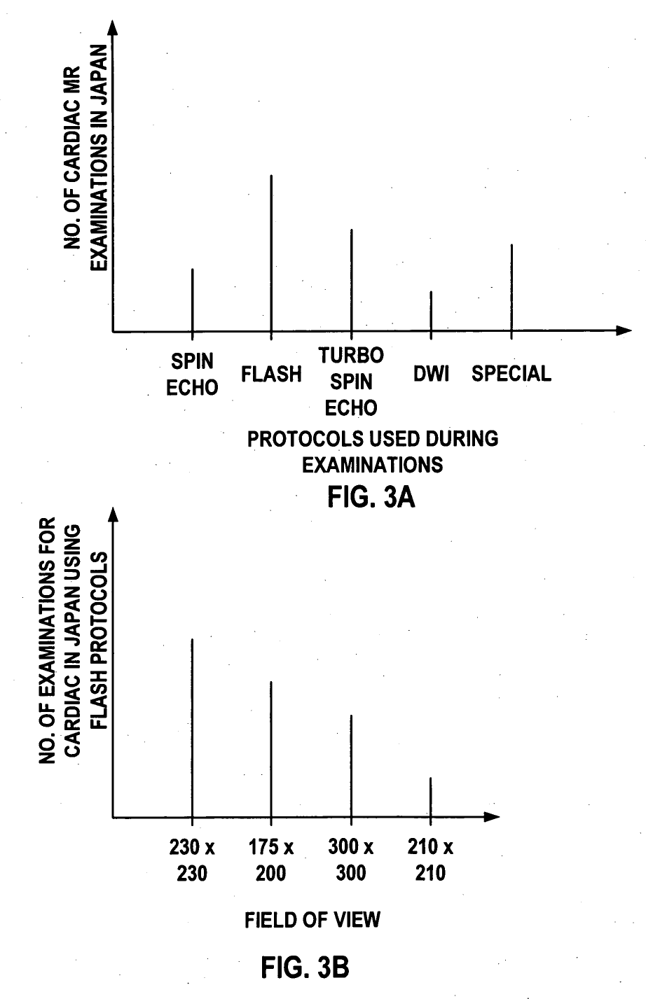

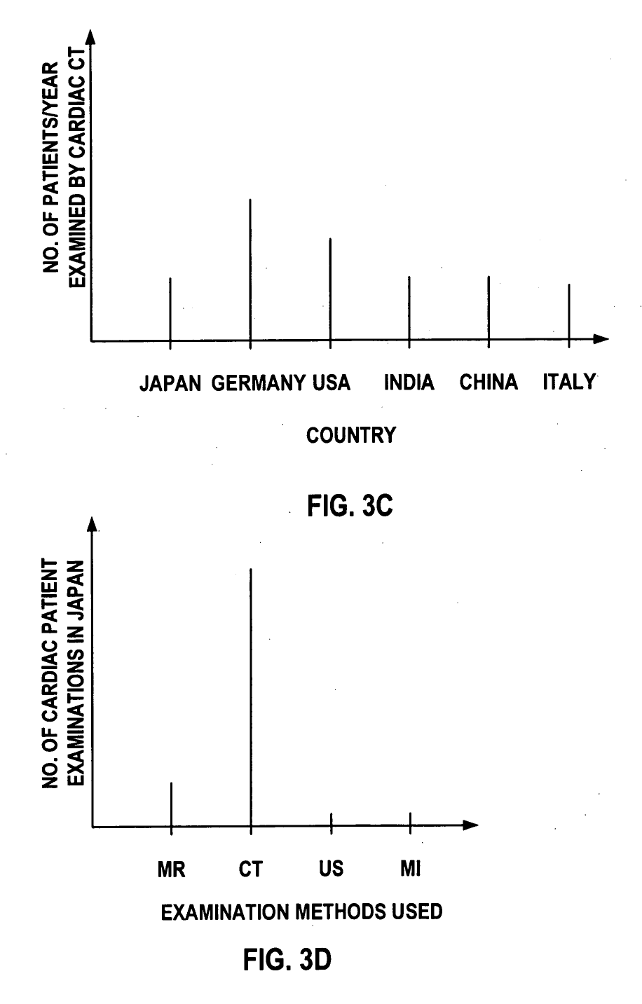

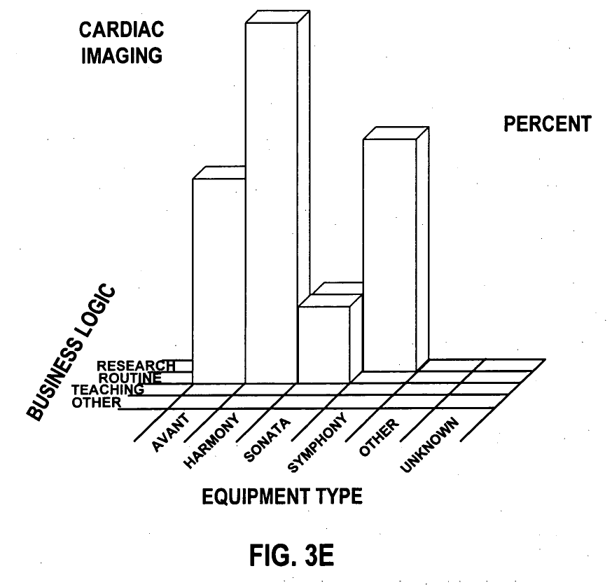

With regard to the type of trend and analysis information that can be displayed, FIGS. 3A-E illustrate a use of combining various parameters, such as those identified above, and displaying the information in 2- or 3-dimensional graphs. Of course, any known technique for displaying the correlated parameter data may be utilized.

FIG. 3A illustrates an exemplary illustration of the number of cardiac MR cases as related to various protocols used during exams in Japan, showing a categorical breakdown of spin echo, flash, turbo spin echo, dwi, and special. The user can, e.g., select these parameters from a list of parameters presented on a display. FIG. 3B illustrates a plot of the number of parameters used in the flash protocol related to the filed of view. Similarly, FIG. 3C shows a categorical breakdown of the number of patients examined by cardiac CT per year by country, and FIG. 3D shows a breakdown of the number of patents in Japan based on examination methods used in cardiac.

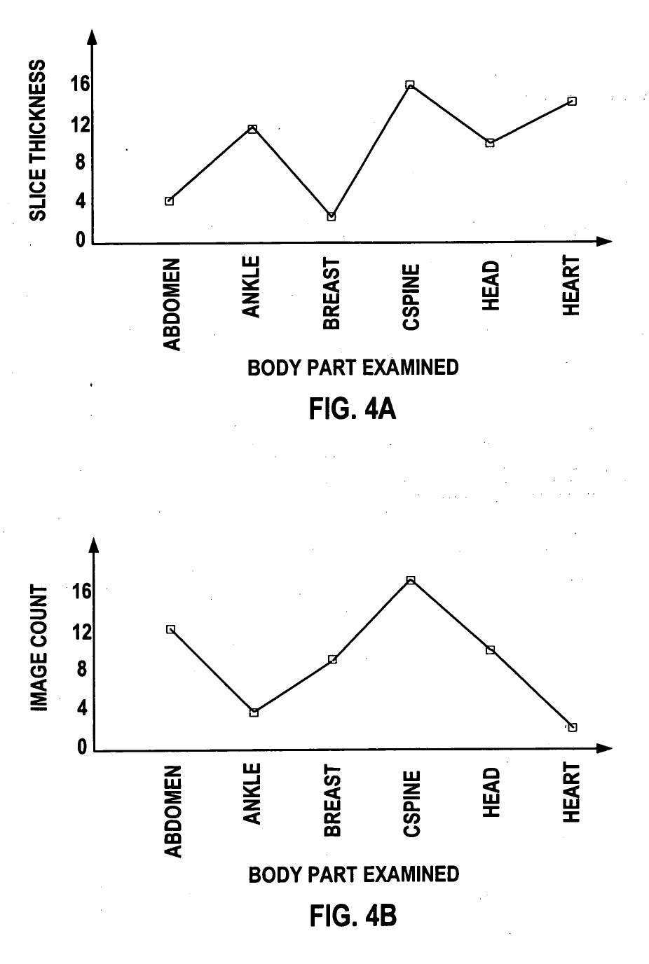

The above examples are based on 2-dimensional graphs, however, the user may chose to plot three or more variables against each other, as is illustrated in FIG. 3E, which shows percentage of cardiac imaging based on the type as well as the use. FIGS. 3A-E were shown as bar graphs, although it is possible to use any graphical form, such as the line graphs illustrated in FIGS. 4A, B and reflecting, based on a parameter of body part examined, the slice thickness (FIG. 4A) and the image count (FIG. 4B) respectively.

These examples have utilized categorical parameters in conjunction with integer based values, but any form of continuous data representation is also contemplated by the invention.

This system provides the possibility to generate a report for the customer showing the usage or other relevant information about his facility. Currently, a list of parameters are evaluated and shown in graphical form providing the platform for improving the workflow, staff requirements, equipment acquisitions and product advances, etc. Beside the obvious benefits for the customer there is a huge potential in these data that could be tapped by external providers of goods and services. All available information regarding the operation of medical facilities under normal and even abnormal working conditions can and should be used as input to R&D efforts within and external to the facilities, as this provides unparalleled insight into the real working environment and workflow. Having representative data of a huge volume of sites worldwide over a lengthy period of time gives everyone the chance for optimizing workflow sequences along with standardization of imaging routines. Taking advantage of the provided information will lead to a wide range of improvements in fields currently not even aware of this potential.

A further embodiment of the invention could be to provide a simulation tool to view improved performance of the clinical facility based on a theoretical change in various parameters.

It should be noted that in implementing the clinical trend detection system, there are important issues to be considered. First, customer agreement (insight into customer's working environment) is essential because the customer is sharing its valuable data. Business implementation must be dealt with in a professional manner, possibly through explicit contacts or agreements. Second, the scope of synchronization with other entities must be considered, since it may not be of benefit to share all information in every situation. Finally, a proper identification of general parameters that describe certain states and/or workflow steps along with other crucial information is required for drawing the correct conclusions out of the collected data.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and skilled in this art without departing from

What is claimed is:

1. A method for structuring, producing, and sharing data related to clinical trends and business logic, comprising:
one or more medical facilities:
a) inputting unstructured data at a first medical facility into a data classifier;
b) automatically structuring the unstructured data by the data classifier utilizing a rule database into predefined facility categories, based on predetermined parameters;
c) outputting the structured data by the data classifier into a structured data store that is segregated by the predefined facility categories; and
d) transmitting data from the structured data store of the first medical facility to a clinical trend detection system;
performing steps (a)-(d) for each of the one or more medical facilities;
storing the transmitted structured data in a database associated with the clinical trend detection system;
statistically analyzing the stored data in the database and producing summary and trend information; and
providing feedback data based on the summary and trend information to the plurality of medical facilities.

2. The method according to claim 1, wherein the predefined facility categories comprise clinical performance data, operational performance data, financial performance parameter data, anonymized patient data, business logic component data, and quality assurance data.

3. The method according to claim 1, wherein the statistical analysis further comprises:
storing external information not directly obtained from the structured data at the medical facility in external databases; and
utilizing the external information during the statistical analyzing of the stored data.

4. The method according to claim 3, wherein the external information comprises information related to a knowledge database, market intelligence, business logic, competition, and decision support system.

5. The method according to claim 1, wherein creating the rule database comprises utilizing personnel from the medical facility to specify a mapping of the unstructured data into the structured data according to the predefined facility categories.

6. The method according to claim 1, further comprising:
utilizing secure access mechanisms for accessing at least one of the structured data at the medical facility and the feedback data.

7. The method according to claim 6, wherein the secure access mechanisms include at least one of: a) using a virtual private network across which the structured data and feedback data travel; b) using a username/password combination for access; and c) using a biometric input device.

8. The method according to claim 1, wherein the feedback data comprises a graphical display of charts or graphs on a user interface device.

9. The method according to claim 8, wherein the graphical display includes 2- or 3-dimensional bar graphs, based on user-selected parameters.

10. The method according to claim 1, wherein the transmitting of the data to the clinical trend detection system comprises transmitting the data over a wide-area network to the remotely located trend detection system.

11. The method according to claim 1, wherein the structuring of the unstructured data further comprises:
substituting a unique identifier in the place of a patient name in a patient record to de-identify or anonymize data associated with a particular patient.

12. The method according to claim 1, wherein the data classifier utilizes at least one of an artificial neural network classifier, Bayesian methods, genetic algorithms, and estimation methods.

13. The method according to claim 2, wherein the business logic component data is a function of weighted financial performance parameters, weighted operational performance parameters, and weighted clinical performance parameters.

14. The method according to claim 2, wherein the financial performance parameter data is a function of weighted operational performance parameters and weighted clinical performance parameters.

15. The method according to claim 2, wherein clinical trends are defined as a function of weighted clinical performance parameters and operational performance parameters.

16. The method according to claim 1, wherein feedback data is represented utilizing XML files and protocol.

17. The method according to claim 1, wherein the feedback data is based on predefined report criteria.

18. A system for detecting trends from medical facilities, comprising:
a medical facility comprising:
an unstructured data store comprising data related to the medical facility;
a rule database comprising rules for mapping unstructured data into predefined facility categories and based on predetermined parameters;
a data classifier having an input that receives the unstructured data and an output that outputs structured data utilizing the rules in the rule database; and
a structured data store that receives the structured data from the data classifier;
the system further comprising:
a clinical trend detection system, comprising:
an input for a communications link that connects the clinical trend detection system with the structured data store;
a data store into which data from the structured data store is held;
a statistical analysis module for statistically analyzing the stored data in the database;
an output via which summary and trend information provided by the statistical analysis module is provided; and
a link to the medical facility at which feedback data based on the summary and trend information is provided.
